(19) United States
(12) Patent Application Publication
(10) Pub. No.: US 2019/0026370 A1
(43) Pub. Date: Jan. 24, 2019

(54) System and Method for Categorizing Web Search Results

(71) Applicants: Eveline Helen Brownstein, Rumson, NJ (US); Kevin Thomas Squires, Rumson, NJ (US)

(72) Inventors: Eveline Helen Brownstein, Rumson, NJ (US); Kevin Thomas Squires, Rumson, NJ (US)

(21) Appl. No.: 15/655,023

(22) Filed: Jul. 20, 2017

(51) Int. Cl. G06F 17/30; H04L 29/08

(52) U.S. Cl. CPC G06F 17/30867; G06Q 30/00; H04L 29/08; H04L 67/02

(57) ABSTRACT

The present invention relates to a system and method for storing, organizing and retrieving internet web pages. Internet web site data is indexed. Businesses and websites provide profiling information. This information is validated using a combination of computerized and human processes. A search engine uses the merger of these two data stores to return searcher driven, relevant and categorized results including business and website owner driven promotions.

### FIELD OF THE INVENTION

The present invention relates to an information retrieval system for indexing, searching and categorizing documents in a large-scale corpus, such as the internet.

### BACKGROUND OF THE INVENTION

Information on the Internet is not fully categorized to provide the most relevant search results to the user. Although search engines seemingly provide search results that are relevant to users, the limited ranking algorithms in use today prevent many of the websites from being found.

Current ranking is typically based on search engine optimization advertising dollars being spent; how many other websites link to the website; or, on the website's social media presence. Search engine optimization has led to an astronomical number of web pages being added to the internet merely in an attempt to increase a website's ranking in search results.

Current search engines have tried to solve this problem by dividing the search results into limited different categories such as images, videos, and news. This, however, does not solve the problem for a business website owner who is looking for traffic to their site, or for the internet searcher who is looking for relevant data to answer their queries.

Web directories also try to list web sites in different categories. However, these types of directories are difficult for users to navigate and do not make effective use of key word searching.

### SUMMARY OF THE INVENTION

An information retrieval system that uses website profile data to categorize and organize the indexed website information and provide an enhanced relevancy score. This enables internet searchers to use key word phrases for searching, and the ability to view results which are categorized into in one or more category folders with sub-categories, when applicable.

The invention is a computer implemented method of capturing and storing profile information about a business or a website which is provided by the website owner through a registration process. Using a combination of human and computer verification methods, the profile information provided is validated and approved for accurate categorization.

Tools are provided to the website owners to enable them to access a platform for adding promotional advertising to the returned search results as they appear in the categorized folders.

Tools that enable internet searchers to enter searching keywords or phrases and retrieve relevant and categorized search results. Searchers can then choose which categorized folder most closely matches the searchers requirements and view only those results, if desired. In addition, searchers will have tools that enable them to define criteria for their search results, such as, but not limited to, distance, or relevance, most popular, etc.

In order to return those results as described above, the keyword search will be sent to the index server in order to retrieve documents, sorted by relevancy. In addition, the keyword search will be sent to the website profile server to retrieve categorization information as well as additional information relevant to the keyword search. Data from the profile server will be sent to the promotion server to retrieve relevant promotional data. The data retrieved from the profile server will be used to combine documents retrieved from the index server that have common URLs. The relevancy scores in this data set will then be adjusted by data retrieved from the profile server. This data set will be added to the promotional data set and then returned to the searcher user.

### BRIEF DESCRIPTION OF THE DRAWINGS

FIG. 1. Block diagram of the software architecture of one embodiment of the present invention

FIG. 2. Diagram of the dynamic categorization that is provided to the searcher user.

### DETAILED DESCRIPTION OF THE INVENTION

The detailed description set forth below, in connection with the appended drawings is intended as a description of the presently preferred embodiments of the invention and is not intended to represent the only forms in which the present invention may be constructed and/or utilized.

1. System Overview:

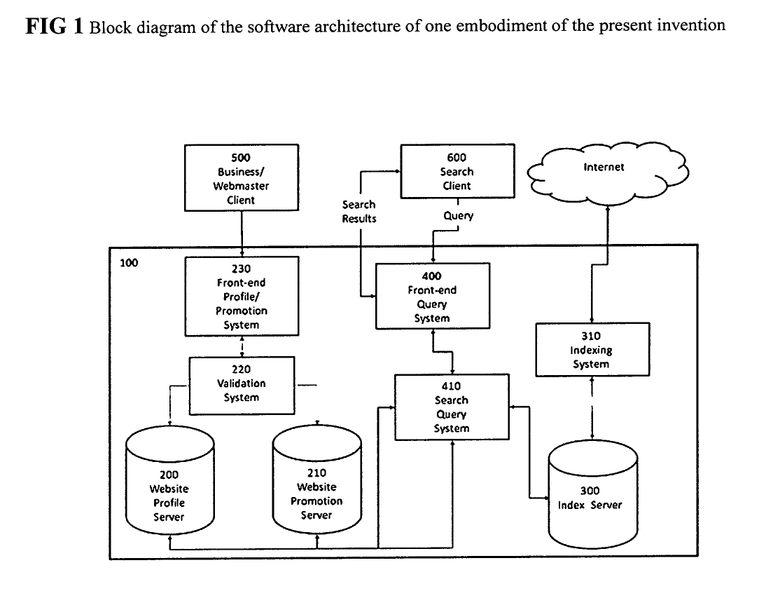

Referring to FIG. 1, showing the system architecture of an embodiment of a search system (100), in accordance with one embodiment of the present invention. In this embodiment, the system includes an indexing system (310), a profile/promotion system (230), a profile validation system (220), a search query system (410), and a front-end query system (400). The front-end profile/promotion system (230) will retrieve data from business and or website owner subscribers and feed to the validation system (220). The validation system will use a combination of algorithms and human verification before storing the data in the website profile server (200) and the website promotion server (210)

The Indexing System (310) is responsible for gathering and indexing documents and providing relevancy and storing them in the index server (300) which will be used to provide relevancy scores against search terms/keywords which are being analyzed.

The front-end query server (400) will receive keywords or phrases from the search client (600) and will feed these to the search query system (410). The search query system will then send these keywords or phrases to the index server (300), the website profile server (200) and the website promotion server (210) and will manage the data returned from each.

2. Front-End Profile/Promotion System:

This system (230) will be used to gather pertinent information about a business or website from the client (500), including but not limited to, company name, description of goods or services, selection of one or more categories as defined within the system; and, a selection of one or more sub-categories as defined within the system. In addition, this system will be used to allow the business to or website owner to enter promotional materials that will be linked to their record when returned in search results.

3. The Validation System:

In order to ensure relevant search returns and appropriate categorization of the search returns, the data provided by the business or website in the profile promotion system (230) will be validated against available industry data and visually validated by internet archivists. Once this validation is complete, the data provided will be stored in the Website Profile Server (200) and Website Promotion Server (210).

4. The Indexing System:

This system (310) will be used to gather documents from the internet. The system will identify words and phrases in the documents and how often they occur. It will also analyze the relative position between words and phrases within the documents. This data will then be stored within the index server (300).

5. The Front-End Query System:

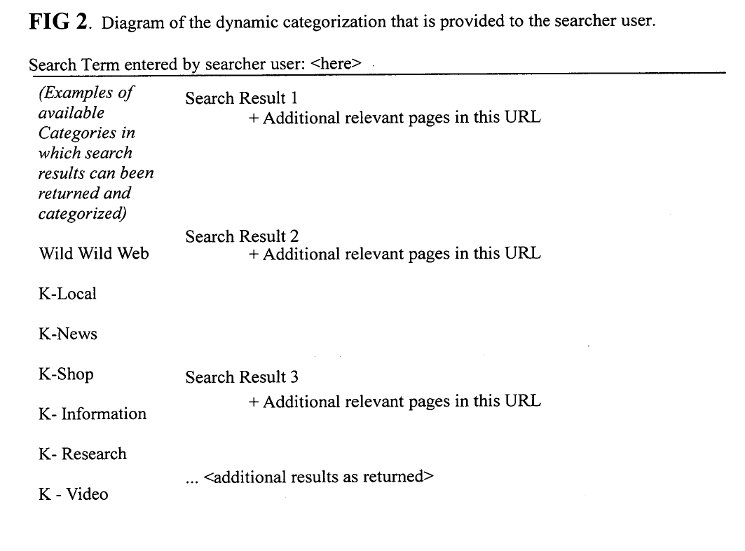

This system (400) will be used to retrieve keywords or phrases entered by the Search Client (600) and will route that inquiry to the Search Query System (410). In addition, this system will return and display the query results received from the Search Query System (410) to the Search Client (600). See FIG. 2 for example of search results display with dynamic categorizations.

6. Search Query System:

This system (410) will accomplish the following steps:
a. Send the search terms received from the Front End Query System (400) to the Index Server (300). The Index Server (300) will return the appropriate documents, sorted by relevancy, based on the search terms provided.
b. Send the search terms to the Website Profile Server (200). The Website Profile Server (200) will return information on the business/website, including but not limited to, the categories within which the business or website operates and a detailed description of the business and/or website.
c. It will retrieve any promotional data entered by the business or website from the Website Promotion Server (210).
d. The data provided by the Website Profile Server (200) will be used to combine the documents returned by the Index Server (300) where the documents are from the same source (URL).
e. The categorization information provided by the Website Profile Server (200) will be used to categorize the results created in Step d, above.
f. The data provided by the Website Profile Server (200) will be used to enhance the relevancy of the data created in Step e, above.
g. The promotional data retrieved in Step c, above, will be combined with the data created in Step f, above, and the resulting data will be returned to the Front-end Query System (400)

1. A computer-based system comprising: Stored subscriber business profile and/or website data; stored subscriber promotional advertising data; a method for internet searchers to return search queries; the ability to retrieve and return relevant, categorized results pursuant to user defined filters using relevance algorithms, or distance criteria, or other user-defined criteria, or a combination of each.

2. The invention of claim 1 further comprising a computer implemented method of capturing and storing subscriber business profile and /or website information provided by the subscriber business or website owner.

3. The invention of claim 2 further comprising a multi-step process for validating the subscriber business and/or website profile information.

4. The invention of claim 1 further comprising a computer implemented method of the capturing and storing of promotional materials provided by a subscriber business or website owner.

5. The invention of claim 1 further comprising a method, wherein a computer index server receives the search phrase matches it against the subscriber business profile and/or website profile stored data as described in claim 2; and against stored and indexed website information using algorithms to return a search result set which is organized in pre-defined categories, ordered by defined relevancy criteria, and also grouped by parent URL.

6. The invention of claim 1 further comprising a computerized method to return the relevant, categorized results displayed such that the searcher user can review returned results in organized categories and sub-categories as described in claim 5.
